(19) United States
(12) Patent Application Publication
(10) Pub. No.: US 2016/0213024 A1
(43) Pub. Date: Jul. 28, 2016

(54) METHOD FOR PRODUCING CHEWING-GUM WITH IMPROVED HARDNESS, CONTAINING XYLITOL, USING AN ANTI-CAKING AGENT, AND CHEWING-GUM THUS OBTAINED

(71) Applicant: ROQUETTE FRERES, Lestrem (FR)

(72) Inventors: Dominique ORTIZ DE ZARATE, Merville (FR); Jose LIS, La Gorgue (FR); Guillaume RIBADEAU-DUMAS, Lestrem (FR)

(21) Appl. No.: 14/914,797

(22) PCT Filed: Sep. 2, 2014
(86) PCT No.: PCT/FR2014/052161

§ 371 Date: Feb. 26, 2016

(30) Foreign Application Priority Data
Sep. 2, 2013 (FR) 1358382

(51) Int. Cl. A23G 4/10

(52) U.S. Cl. CPC A23G 4/10; A23V 2002/00

(57) ABSTRACT

A method for producing chewing-gum compositions containing xylitol introduced in the form of a powder as polyol, by introducing into the compositions at least one anti-caking agent, preferably having a specific surface BET of at least 200 m²/g. The hardness of the chewing-gum thus obtained is increased, such an increase being desirable, for example, for preventing the deformation of centers to be sugar-coated in the sugar-coating turbines or improving the stick-packaging rates. The anti-caking agent is previously mixed with the powdery xylitol, and the mixture may be provided in the form of a powdery composition of xylitol and the anti-caking agent.

The present invention relates to a method for manufacturing a chewing gum composition containing xylitol as polyol, said method being characterized in that at least one anti-caking agent is mixed with the other constituents of the chewing gum composition. The hardness of the chewing gums obtained in this way is increased, such an increase being desirable, for example to avoid deformation of the centers to be sugar-coated in sugar-coating pans, or to improve the stick packaging rates.

The anti-caking agent is mixed beforehand with the xylitol in pulverulent form. The combination resulting from the mixing of the anti-caking agent and the pulverulent xylitol composition is also part of the invention.

Throughout the present patent application, the expressions “xylitol in powder form” or “pulverulent xylitol composition” denote a composition containing xylitol, characterized in that it has a solids content equal to at least 97%, preferably at least 98%, very preferably at least 98.5% of its total weight (pulverulent character), said solids being represented, to more than 85%, preferably to more than 90%, very preferably to more than 91% by weight, by xylitol (xylitol composition).

Current chewing gum compositions, formulated with or without sugar, of the bubble gum type or not, which are optionally sugar-coated, contain at least one non-hydrosoluble gum base, at least one sugaring agent in powder or liquid form, and at least one flavoring. They may also contain, nonexhaustively, colorants, emulsifiers, plasticizers, intense sweeteners, food lubricants, pharmaceutical ingredients, water, etc.

When they are made without sugar, chewing gum compositions mostly contain xylitol as sugaring agent. Xylitol is a polyol with 5 carbon atoms, resulting from the hydrogenation of xylose. It is used as a substitute substance for sugar and/or as a support substance in pharmaceutical preparations and in the food industry, in particular in the form of tablets to be sucked or chewed. In the context of chewing gum compositions, it is generally present in the form of a powder (pulverulent xylitol composition).

Conventionally, and as described for example in the document “Chewing gum sans sucre à base de maltitol” [Sugar-free chewing gum based on maltitol] (Maruyama T., Terasawa M., Takiguchi T., Shokuhin Kôgyô, 1984, 27, no. 24, pp. 73-80), the chewing gum composition is made by mixing, under hot conditions, the various constituents in a Z-arm mixer with a jacket kept in general between 45° C. and 80° C. The product is then shaped by extrusion, rolling, cutting and cooling and then packaged, transported to its place of sale where it is held until consumption. There may therefore be several days, or even several weeks, between the time of its manufacture and the date of its consumption. However, the hardness of this composition is an important characteristic which must be kept as high as possible throughout the whole storage period but also throughout the manufacturing process (to avoid deformations in the sugar-coating pans or to optimize the stick packaging rates).

Hardness is a mechanical characteristic well known to those skilled in the art, which may be easily understood by a test of the same name, using a device known as a penetrometer or texture analyzer. The principle of the experiment consists in measuring the extent to which a face of a sample resists penetration by a harder body such as a tip or a ball.

In the case of a chewing gum, this hardness is directly linked to sensory characteristics which are perceived during consumption: the hardness at first chew and the mouthfeel. Excessive hardness at first chew is unpleasant. Good mouthfeel is in contradiction especially to the sensation perceived in the presence of too soft a paste.

Generally, it will be sought to increase the hardness of chewing gums if it is desired to use a gum base which gives a very flexible/soft chew, if it is desired to introduce a lot of liquid flavoring into the chewing gum, or else if it is sought to introduce a large amount of liquid phase (for example glycerol or Lycasin® 85/55 or Lycasin® 80/55 maltitol syrup sold by the applicant) in order to reduce the manufacturing cost.

A means well known to those skilled in the art for adjusting the hardness of the chewing gum composition is to vary the amount of glycerol contained therein and/or the ratio of sugaring agent introduced in liquid form and in powder form; this is especially reported in document WO 2011/109376. However, by their nature, these techniques necessitate significant modifications to the formulation of the composition in terms of amounts of products used: such modifications are not necessarily desired by the formulator.

Consequently, there is a great need to have a method for manufacturing a chewing gum composition containing xylitol in powder form that is both simple to implement, without necessitating significant modifications in terms of amounts of products used, and which finally leads to a product with significantly improved hardness which is retained over time. Working with this in mind, the applicant has been able to develop such a method. This method is based especially on the introduction of an anti-caking agent into the chewing gum composition, said agent being introduced as a direct additive into the chewing gum composition (that is to say mixed with the other ingredients including the pulverulent xylitol) or being introduced in combination with the pulverulent xylitol composition (that is to say mixed beforehand with the xylitol in powder form).

Thus, a first subject of the invention consists of a method for manufacturing a chewing gum composition, by mixing of:
at least one gum base,
at least one pulverulent xylitol composition,
at least one flavoring, and
at least one anti-caking agent.

The term “anti-caking” denotes the ability of a compound to avoid/reduce problems of powder caking, that is to say the phenomenon of agglomeration of individual particles making up said powder, such a phenomenon being especially linked to the presence of moisture.

The anti-caking agent may be introduced alone, by mixing with the 3 abovementioned compounds (the gum base, the flavoring and the pulverulent xylitol composition) and optionally with other compounds as explained further below.

The method according to the invention is characterized in that the anti-caking agent is firstly mixed with the pulverulent xylitol composition, before subsequently being mixed with the gum base, the flavoring and optionally other compounds explained further below. In this case, the anti-caking agent is not used as a direct additive, but carried by the pulverulent xylitol to within the chewing gum composition.

The anti-caking agent/pulverulent xylitol are mixed beforehand using any methods for mixing powders (especially in batch mode or continuous mode) which are well known to those skilled in the art. By way of batch mixers which may be used, mention may especially be made of the mixers sold by the companies Turbula, Lodige, Forberg and Gericke; as regards continuous mixers, mention may be made of the devices sold by the companies Lodige, Forberg and Gericke.

The anti-caking agent has a BET specific surface area of at least 200 m²/g.

Among the anti-caking agents recommended by the applicant, mention may be made nonlimitingly of silicas, and preferably fumed, colloidal, precipitated and amorphous silicas, silicon oxides, sodium aluminum silicates, talc, calcium carbonate, magnesium oxide, tricalcium phosphate, dehydrated potato starch (and preferably potato starch dehydrated to less than 12%, preferably less than 8%, preferably to 6% by weight of residual water), sodium ferrocyanide, potassium ferrocyanide and iron hexacyanomanganate.

Preferably, the anti-caking agent is chosen from fumed, colloidal, precipitated and amorphous silicas, and from those having a BET specific surface area of at least 200 m²/g.

The examples which illustrate the present patent application demonstrate all the advantages of having an anti-caking agent with a high BET specific surface area. Throughout the remainder of the patent application, the phrase “compound having a high BET specific surface area” may be used instead of “compound having a BET specific surface area of at least 200 m²/g”.

In this method, the chewing gum composition manufactured has from:
4.5% to 95%, preferably 5% to 95%, more preferably 20% to 50% of at least one gum base,
1% to 95%, preferably 10% to 65% of a pulverulent xylitol composition,
0.1% to 10%, preferably 0.1% to 3% of at least one flavoring,
   these % being given by dry weight relative to the total weight of said chewing gum composition;

and this composition also has from 0.1% to 20%, preferably 0.1% to 5% by dry weight of at least one anti-caking agent, this % being measured relative to the dry weight of xylitol.

The chewing gum composition is therefore that which results from the mixing of the abovementioned compounds, said mixture subsequently undergoing operations of extrusion, rolling, cutting, cooling then packaging, which lead to the finished chewing gum. This step of mixing is of course separate from the step of mixing of the anti-caking agent and the pulverulent xylitol composition, according to the second variant of the method of the invention.

Entirely unexpectedly, using the anti-caking agent leads to a finished product with a considerably improved hardness compared to that of a product coming from the same method but without the use of an anti-caking agent. It is verified on the one hand that this hardness is reinforced in the course of the method for manufacturing the chewing gum by measuring the hardnesses at 45° C., 35° C. and 20° C. at the time of manufacture, and on the other hand that this level of hardness is retained over a period of storage at 50% relative humidity and 20° C. that may reach 15 days.

It is recalled that in the present patent application, the expression “pulverulent xylitol composition” denotes a composition containing xylitol, characterized in that it has a solids content equal to at least 97%, preferably at least 98%, very preferably at least 98.5% of its total weight (pulverulent character), said solids being represented, to more than 85%, preferably to more than 90%, very preferably to more than 91% by weight, by xylitol (xylitol composition).

The method according to the invention thus comprises at least one step of mixing of the abovementioned compounds:
the gum, the pulverulent xylitol composition, the flavoring and the anti-caking agent, in a first variant,
the gum, the pulverulent xylitol composition with the anti-caking agent having been added to it beforehand, and the flavoring, in a second variant.

The characteristics of this step of mixing will now be stated (which step, as already indicated, is separate from the step of mixing of the anti-caking agent and the pulverulent xylitol). The applicant recommends carrying out this mixing at a temperature of between 45° C. and 80° C., preferably in a Z-arm mixer with a jacket. Preferably, it is advisable to heat the gum base beforehand to a temperature of between 45° C. and 80° C., preferably between 45° C. and 55° C., by any means known to those skilled in the art. By way of example, it will be possible to heat it in a microwave oven or an oven.

The mixing of the abovementioned compounds may also employ another polyol as sugaring agent, in powder or liquid form, such as, for example, mannitol, maltitol, maltitol, erythritol, lactitol, isomalt, maltitol syrups, sorbitol syrups or hydrogenated glucose syrups. Said polyol is then present in an amount of at most 20% by weight, relative to the total weight of the chewing gum produced.

The mixing of the abovementioned compounds may also employ, in an amount of at most 5% by weight relative to the total weight of the chewing gum, at least one constituent chosen from colorants, intense sweeteners, such as aspartame, acesulfame-K, alitame, neotame, sucralose, saccharin, neohesperidin DC, steviosides, brazzein, pharmaceutical active agents, minerals, plant extracts, antioxidants, indigestible fibers, such as, for example, oligosaccharides, such as fructo-oligosaccharides, indigestible fibers, such as Fibersol™, sold by Matsutani, or else NUTRIOSE™ FB, sold by the applicant, emulsifiers, such as lecithin, etc.

The gum base used may be adapted to the type of chewing gum manufactured. It may comprise synthetic and/or natural elastomers, such as polyisoprene, polyvinyl acetate, polyisobutylene, latexes, resins, such as terpene resins, polyvinyl esters and alcohols, fatty substances or waxes, such as, for example, lanolin, vegetable oils that are optionally partially hydrogenated, fatty acids, glycerol partial esters, paraffin or microcrystalline waxes.

The xylitol used in the abovementioned pulverulent composition preferably exhibits a BET specific surface of between 0.1 m²/g and 10 m²/g.

In manufacturing the chewing gum composition, the step of mixing the abovementioned ingredients is followed by steps of extrusion, rolling, cutting, cooling then packaging, carried out according to any technique well known to those skilled in the art. It is possible to refer to the experimental section illustrating the present patent application, but also to the abovementioned document “Chewing gum sans sucre à base de maltitol” [Sugar-free chewing gum based on maltitol]. In the end, the chewing gum is present in one of the forms well known to those skilled in the art, such as sticks, balls, sugar-coated pills, cubes or else tablets.

Another subject of the present invention is a pulverulent xylitol composition containing at least one anti-caking agent. This composition also contains from 0.1% to 20%, preferably from 0.1% to 5% by dry weight of said anti-caking agent relative to the dry weight of xylitol.

This pulverulent composition therefore contains by way of example at least one of the abovementioned anti-caking agents. Thus, the anti-caking agent has a BET specific surface area of at least 200 m²/g. Preferably, the anti-caking agent is chosen from fumed, colloidal, precipitated and amorphous silicas having a BET specific surface area of at least 200 m²/g.

Another subject of the present invention consists of the use of the abovementioned pulverulent composition in a method for manufacturing chewing gum.

Finally, another subject of the present invention consists of a chewing gum composition containing, with percentages being given by dry weight relative to the total weight of the mixture obtained:
from 4.5% to 95%, preferably from 5% to 95%, more preferably from 20% to 50% of at least one gum base,
from 1% to 95%, preferably from 10% to 60% of a pulverulent xylitol composition,
from 0.1% to 10%, preferably from 0.1% to 3% of at least one flavoring,
   and from 0.1% to 20%, preferably from 0.1% to 5% by dry weight of at least one anti-caking agent, this amount being expressed by dry weight relative to the dry weight of xylitol.

The anti-caking agent according to the present invention has a BET specific surface area of at least 200 m²/g.

Preferably, the anti-caking agent is chosen from fumed, colloidal, precipitated and amorphous silicas, and from those having a BET specific surface area of at least 200 m²/g.

This chewing gum composition also has a hardness at least equal to 10 N measured at 20° C. The applicant points out that, in the present patent application, the hardness is measured according to the operating protocol as described in the introductory part of the examples, which protocol specifies the thickness of the compositions tested (bearing in mind that the hardness is dependent on this thickness).

A better understanding of the invention will be obtained on reading the following examples, which cannot in any way limit the present invention.

### EXAMPLES

In the examples, the hardness is measured on a texture analyzer (Instron) provided with a cylindrical punch, the rate of penetration of which is adjusted to 50 mm/minute. The hardness corresponds to the maximum force observed while the punch passes completely through the sample (rectangular parallelepiped: 30×17×5 mm).

In the present patent application, the BET specific surface area is measured using a Beckman-Coulter SA3100 device.

In the case of the xylitol, the method consists initially in sieving a sufficient amount of sample over sieves making it possible to recover approximately 3 grams of a particle size fraction between 841 and 250 microns. In the case of the anti-caking agents, this sieving stage does not exist.

A sample is introduced into a measurement cell dried beforehand and tared to within 0.001 g, the sample being sufficient to ¾ fill the reservoir of the cell. The cell is then placed at the degassing station. Degassing having been carried out, the cell is reweighed to within 0.001 g and placed at the measurement station. The device processes the data and gives a result in m²/g.

### Example 1

This example relates to the manufacture of various chewing gum compositions containing xylitol in powder form, optionally in a mixture with a silica. For each composition, the change in hardness during the cooling thereof during manufacture was monitored, after the step of mixing the various constituents under hot conditions.

A first type of composition is composed of, expressed in % by dry weight of each of the constituents thereof relative to the total weight thereof:
Gum base Suncom T®: 35.00%
Pulverulent xylitol composition: 61.00%
Glycerol: 0.50%
Maltitol syrup, Lycasin® 85/55: 2.50%
Mint/vanilla flavoring (liquid): 1.00%

The chewing gum is produced according to the following protocol:
The gum base is heated in a microwave oven and introduced into the mixer.
Half of the pulverulent xylitol composition is added and mixing is carried out for 3 minutes.
The maltitol syrup Lycasin® 85/55 is added and mixing is carried out for 2 minutes.
The second half of the pulverulent xylitol composition and the liquid flavoring are added and mixing is carried out for 3 minutes.
The glycerol is added and mixing is carried out for 2 minutes.
The liquid flavoring is added and mixing is carried out for 2 minutes.
The product is discharged from the mixer, shaped and rolled to a thickness of 5 mm.

When it contains the anti-caking compound or agent with a high BET specific surface area, the pulverulent xylitol composition was produced beforehand by mixing of the two constituents at room temperature.

This formulation makes it possible to produce various compositions depending on the xylitol used, on the presence or absence of a compound with a high specific surface area, and on the amount thereof used. Thus, 7 compositions were produced according to table 1. It is indicated that the xylitol in powder form is the product Xylisorb® 90 sold by the applicant. Tixosil® 331 is a micronized silica sold by the Rhodia group, with a BET specific surface area of the order of 250 m²/g. Finally, the % indicated in the table correspond to the % by dry weight of silica used with respect to the dry weight of xylitol.

The positive influence of the anti-caking agent on the hardness of the finished product is clearly verified for a type of xylitol powder during the process of cooling the chewing gum composition.

TABLE 1

| | Tixosil ® | Tricalcium | Magnesium | Potato | Hardness | Hardness | Hardness |
|---|---|---|---|---|---|---|---|
| Test | 331 | phosphate | stearate | starch | 45° C. (N) | 35° C. (N) | 20° C. (N) |
| 1 | 0 | 0 | 0 | 0 | 1 | 1.8 | 7.5 |
| 2 | 0.50% | 0 | 0 | 0 | 1.1 | 2.2 | 8.5 |
| 3 | 0 | 0.50% | 0 | 0 | 0.9 | 2.1 | 7.45 |
| 4 | 0 | 0 | 5% | 0 | 1.1 | 2.3 | 7.9 |
| 5 | 0 | 0 | 0% | 0.5% | 1.2 | 2.1 | 7.7 |
| 6 | 2.50% | 0 | 0 | 0 | 1.5 | 2.8 | 10.3 |
| 7 | 5.00% | 0 | 0 | 0 | 1.6 | 3.4 | 11.6 |

### Example 2

In this example, the above compositions 1 to 7 were taken again and their hardnesses were monitored over time, at the moments t=1, 8 and 15 days, at room temperature. The results obtained are given in table 2.

TABLE 2

| | Tixosil ® | Tricalcium | Magnesium | Potato | Hardness | Hardness | Hardness |
|---|---|---|---|---|---|---|---|
| Test | 331 | phosphate | stearate | starch | 1 d (N) | 8 d (N) | 15 d (N) |
| 1 | 0 | 0 | 0 | 0 | 7.7 | 6.3 | 6.8 |
| 2 | 0.50% | 0 | 0 | 0 | 9.3 | 6.9 | 7.0 |
| 3 | 0 | 0.50% | 0 | 0 | 8.9 | 7.6 | 7.2 |
| 4 | 0 | 0 | 5% | 0% | 8.8 | 9.7 | 10.9 |
| 5 | 0 | 0 | 0% | 0.5% | 7.9 | 7.6 | 7.6 |
| 6 | 2.50% | 0 | 0 | 0 | 11.7 | 8.7 | 8.1 |
| 7 | 5.00% | 0 | 0 | 0 | 12.9 | 11.9 | 12.0 |

It is clearly verified, for the compositions according to the invention, that this level of hardness is retained over a period of storage at 50% relative humidity and 20° C. that may reach 15 days.

1. A method for manufacturing a chewing gum composition, comprising mixing of:
at least one gum base,
at least one pulverulent xylitol composition,
at least one flavoring, and
at least one anti-caking agent,
wherein:
the anti-caking agent is firstly mixed with the pulverulent xylitol composition, before subsequently being mixed with the gum base and the flavoring; and
the anti-caking agent has a BET specific surface area of at least 200 m²/g.

2. The method as claimed in claim 1, the anti-caking agent is selected from the group consisting of fumed silicas, colloidal silicas, precipitated silicas and amorphous silicas, and the anti-caking agent has a BET specific surface area of at least 200 m²/g.

3. The method as claimed in claim 1, wherein the chewing gum composition has from:
4.5% to 95% of at least one gum base,
1% to 95% of a pulverulent xylitol composition,
0.1% to 10% of at least one flavoring, the % being given by dry weight relative to the total weight of said chewing gum composition,
and wherein the chewing gum composition comprises from 0.1% to 20% by dry weight of at least one anti-caking agent having a BET specific surface area of at least 200 m²/g, the % being measured relative to the dry weight of xylitol.

4. The method as claimed in claim 3, wherein the mixing of:
at least one gum base,
least one pulverulent xylitol composition,
at least one flavoring, and
at least one anti-caking agent having a BET specific surface area of at least 200 m²/g is carried out at a temperature of between 45° C. and 80° C., and the gum base is heated beforehand to a temperature of between 45° C. and 80° C.

5. The method as claimed in claim 1, wherein the mixing of:
at least one gum base,
at least one pulverulent xylitol composition,
at least one flavoring, and
at least one anti-caking agent having a BET specific surface area of at least 200 m²/g is followed by steps of extruding, rolling, cutting, cooling then packaging.

6. A pulverulent xylitol composition comprising at least one anti-caking agent having a BET specific surface area of at least 200 m²/g.

7. The pulverulent xylitol composition as claimed in claim 6, wherein the at least one anti-caking agent having a BET specific surface area of at least 200 m²/g is 0.1% to 20% by dry weight relative to the dry weight of xylitol.

8. The pulverulent xylitol composition as claimed in claim 7, wherein the anti-caking agent is selected from the group consisting of fumed silicas, colloidal silicas, precipitated silicas and amorphous silicas, and the anti-caking agent has a BET specific surface area of at least 200 m²/g.

9. A chewing gum composition comprising, with percentages being given by dry weight relative to the total weight of the mixture obtained:
from 4.5% to 95% of at least one gum base,
from 1% to 95% of a pulverulent xylitol composition,
from 0.1% to 10% of at least one flavoring, and
from 0.1% to 20% by dry weight of at least one anti-caking agent having a BET specific surface area of at least 200 m²/g, the amount being expressed by dry weight relative to the dry weight of xylitol.

10. The chewing gum composition as claimed in claim 9, wherein the anti-caking agent is selected from the group consisting of fumed silicas, colloidal silicas, precipitated silicas and amorphous silicas, and the anti-caking agent has a BET specific surface area of at least 200 m²/g.
